(19) United States
(12) Patent Application Publication
(10) Pub. No.: US 2004/0159023 A1
(43) Pub. Date: Aug. 19, 2004

(54) License plate loover

(76) Inventor: David DeGroote, Mesa, AZ (US)

Correspondence Address: David DeGroote, P. O. Box 50007, Mesa, AZ, 85208, US

(21) Appl. No.: 10/662,187

(22) Filed: Sep. 15, 2003

Related U.S. Application Data
(60) Provisional application No. 60/411,123, filed on Sep. 16, 2002.

(51) Int. Cl. G09F 7/00

(52) U.S. Cl. 40/209

(57) ABSTRACT

The invention of the license plate Loover is to put a stop to unauthorized photos of license plates. A photo of a license plate is not a way to determine weather or not a situation was not the cause of an outcome. The license plate Loover will help to protect people from having their rights violated and to prevent private companies from profiting from and earning royalties off of photos of people's personal property without their authorization.

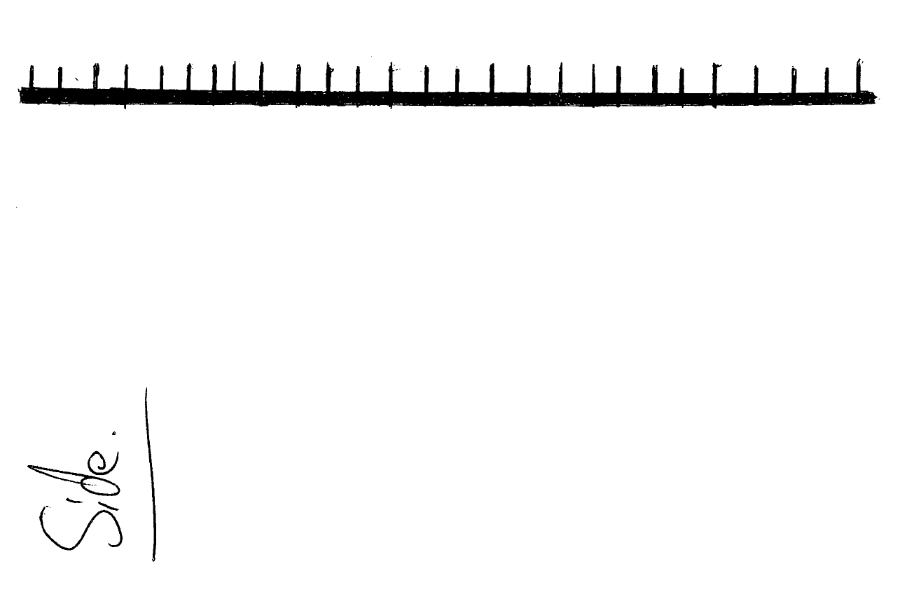

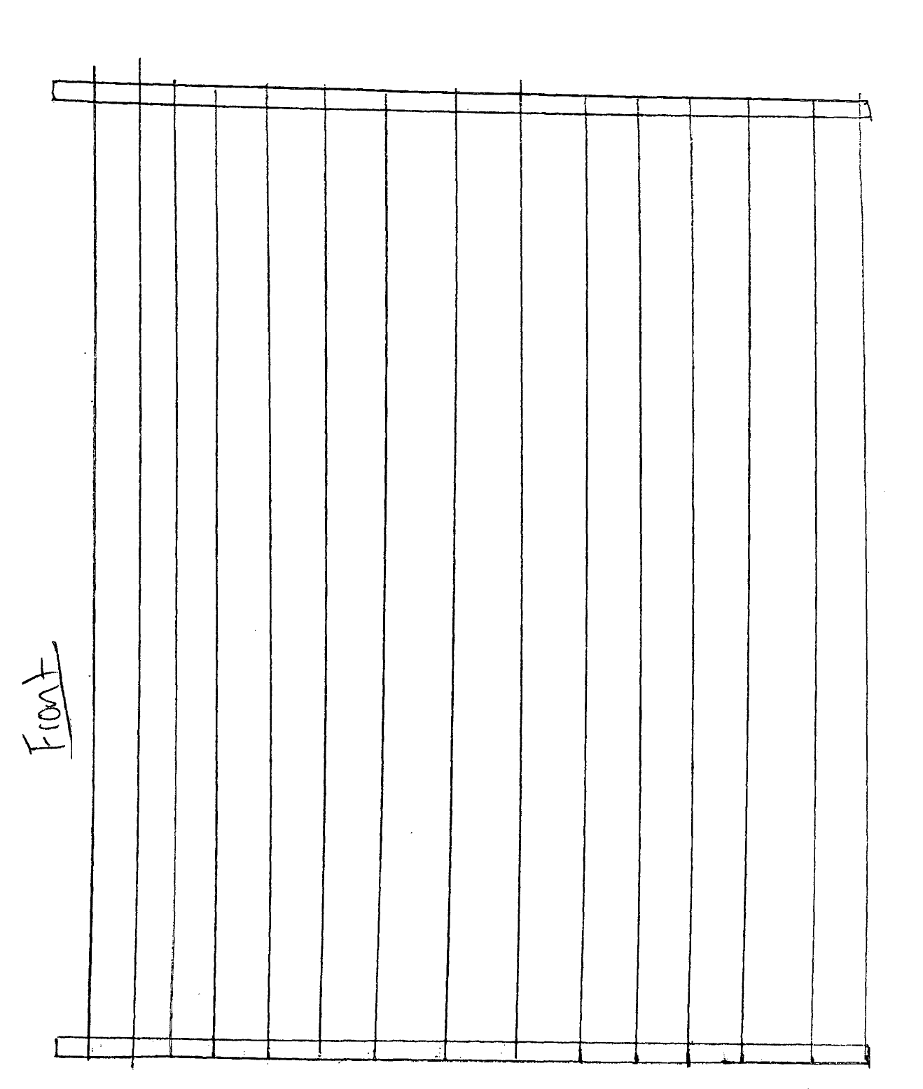

### FED SPONSORED

Derived from Provisional Patent Application No. 60/411,123 confirmation no. 4536

### BRIEF SUMMARY

The License Plate Loover is a device that connects to any vehicle, over the license plate, to prevent unauthorized photos or view of your license plate from above. It is made out of plastic but can be made from almost any material. The ends of the horizontal slats are attached to vertical strips creating the license plate Loover. This is done by either using a mold in one piece or by assembling many different pieces.

### DESCRIPTION OF DRAWINGS

Side view drawing shows all of the slats and that they are connected as one solid piece. Front view drawing shows how it looks

1. The Loover structure uses solid non see-through slats horizontally across (similar to a mini blind) These slats can not be seen through from above or an abrupt angle and are made of a solid material but allow a clear view from straight on.
A. The Loover slats prevent unauthorized photos to be taken of a license plate from above and from an abrupt angle.
B. The Loover slats prevent view of a license plate from above and from an abrupt angle.
C. The Loover slats also blocks glair so that a license plate is clearly visible from behind and all angles that are necessary to comply with law enforcement.
D. The Loover slats prevent tracking or recording of a license plate number from helicopters, satellite and other tracking devices from above.
E. The Loover slats interferes with the resolution of a photo of a license plate by shading many sections of a license plate in a way that makes it hard for digital cameras to process.

2. The Loover serves as a license plate theft deterrent.
A. The appearance of the Loover is a theft deterrent itself. When the Loover is installed it makes a license plate look unreachable.
B. The way the Loover is attached to a license plate makes it difficult to remove the license plate. Bolts are used in place of small screws.

3. The way the Loover attaches to a vehicle allows for adjustment for each specific vehicle by using brake away spacers. The spacers are similar to thick washers but are connected to the back of the Loover and a part of the Loover, this allows for adjustment. When the spacers are broken off, the Loover can be installed with less of a tilt.
